(19) United States
(12) Patent Application Publication
(10) Pub. No.: US 2023/0169338 A1
(43) Pub. Date: Jun. 1, 2023

(54) METHODS FOR TRAINING AND USING AN ARTIFICIAL NEURAL NETWORK TO IDENTIFY A PROPERTY VALUE, AND SYSTEM THEREOF

(71) Applicant: ORANGE, ISSY-LES-MOULINEAUX (FR)

(72) Inventor: Wenbin Li, CHATILLON CEDEX (FR)

(21) Appl. No.: 18/070,923

(22) Filed: Nov. 29, 2022

(30) Foreign Application Priority Data
Nov. 30, 2021 (FR) 2112726

(51) Int. Cl. G06N 3/08

(52) U.S. Cl. CPC G06N 3/08

(57) ABSTRACT

A method for training an artificial neural network so that the artificial neural network identifies a property value among a plurality of property values, each property being able to take at least two different values. The method includes: a primary training including training the neural network to identify at least one target value; and a secondary training for detecting weaknesses of the model trained during the primary training and reinforcing this model by increasing the learning rate of output neurons of the network that are associated with property values most often misestimated.

### TECHNICAL FIELD

The present invention relates to the field of training an artificial neural network to identify a property value, this property value can be of any kind.

### PRIOR ART

It is usual to train a neural network on a set of data so that it is able to identify a property value.

But in many cases, the neural network thus trained is not satisfactory.

There is therefore a need for a solution that allows improving the robustness of a neural network at the end of its learning phase.

### DISCLOSURE OF THE INVENTION

The present invention relates to a method for training an artificial neural network so that said artificial neural network identifies at least one value of a property among a plurality of property values, each property being able to take at least two different values, this artificial neural network including an output layer including, for at least one said property value, a prediction score for said property value;

said method comprising a primary training consisting in training said neural network to identify at least one target property value from a first set of primary training data labeled by associating these data with a first set of target property values,

said method further including a secondary training including the following steps:
obtaining, for at least a first target value of a target property, a set of secondary training data;
identifying an estimated value of the target property associated with at least one said secondary training data, by using the artificial neural network trained by the primary training;
for each estimated value different from the first target value, obtaining a number of confusions corresponding to the number of times said estimated value has been estimated;
increasing the learning rates associated with the neurons of the output layer of the neural network that are associated with values of interest corresponding to estimated values with the largest numbers of confusions.

In one particular embodiment, the primary training includes the following steps:
obtaining the first set of primary training data;
applying the first set of primary training data to the input of the artificial neural network, and
modifying at least one weight of the artificial neural network as a function of the first set of target property values and of the prediction scores obtained.

Correlatively, the invention relates to a system for training an artificial neural network so that said artificial neural network identifies at least one property value among a plurality of property values, each property being able to take at least two different values, the artificial neural network including an output layer including, for at least one said property value, a neuron configured to deliver a prediction score for said property value. This system comprises:
an obtaining module configured to obtain a first set of primary training data labeled by associating these data with a first set of target property values;
an application module configured to apply the first set of primary training data to the input of the neural network, to train, during a primary training, said neural network to identify at least one said target property value,
a modification module configured to modify at least one weight of the artificial neural network as a function of the first set of target property values and of the prediction scores obtained;
said obtaining module being configured to obtain, for at least a first target value of a target property, a set of secondary training data;
said application module being configured to apply, during a secondary training, at least one data of the set of secondary training data to the input of the neural network to identify an estimated value of said target property associated with at least one said secondary training data, by using the artificial neural network trained by said primary training;
said modification module being configured to obtain, for each estimated value different from said first target value, a number of confusions corresponding to the number of times said estimated value has been estimated and to increase learning rates associated with the neurons of the output layer of the neural network associated with values of interest corresponding to estimated values with the largest numbers of confusions.

Once the primary training is completed, a secondary training (or post-training) is implemented in order to detect weaknesses in the model trained during the primary training and to reinforce this model by using targeted data and an adapted learning rate.

This reinforcement is performed by increasing the learning rate of the output neurons of the network that are associated with property values most often misestimated.

In one embodiment, during the primary training, the learning rates associated with the neurons of the output layer of the neural network all have the same value.

In one particular embodiment, the primary training and the secondary training use a gradient backpropagation method and the increase of a learning rate consists in multiplying this learning rate by a constant.

In one embodiment, the artificial neural network is configured to identify a digital use among a set of digital uses, each digital use being described by a digital behavior associated with at least one said property and by a digital environment associated with at least one said property.

This particular embodiment of the invention allows the identification of digital uses at devices called smart devices.

In this embodiment, the primary training consists in training the neural network to identify at least one target digital use among the set of digital uses,
the data of said first set of primary training data being extracted from a first plurality of network packets captured during at least one execution of an application associated with said first target digital use, said primary training data being labeled by associating these data with a first set of target property values describing at least a digital behavior and a digital environment of the first target digital use,
the data of said set of secondary training data obtained for said at least one first target value being extracted from a second plurality of network packets captured during at least one execution of an application associated with a digital use whose said target property is described by the first target value.

The network packets can comprise a lot of information describing behaviors and requirements of the user of the smart device, and the analysis of these network traces is thus useful for example for providing services adapted to the users.

To date, there are packet content analysis techniques that allow inferring a digital behavior by means of predefined rules. However, such techniques use personal data (for example IP and MAC addresses, or unencrypted packet contents), as well as non-immutable data (for example the IP address of a server of a used application can vary depending on the geolocation of the user and depending on updates). These techniques thus do not protect the privacy of the users and lack reliability.

There are also machine learning techniques that allow identifying a single digital property, such as a used application, which does not allow fully defining a digital use.

But there is no solution that allows reliably identifying a digital use.

Thus, and in a very advantageous manner, in this embodiment, the primary training allows training the same neural network to identify several properties describing the digital use, including at least one property describing a digital behavior and a digital environment of this digital use, which improves the reliability and the accuracy of the identification of the digital use.

This primary training further allows the reduction of the trained neural network, which thus consumes less computational resources.

In one particular embodiment, the properties defining the digital use comprise at least one property among the following properties:
a used application category,
a used application,
an operation implemented at the application level,
a user interaction state,
a used device,
a used operating system,
a used browser, and
at least one related characteristic of a communication network, for example an Internet connection speed or a latency.

In one embodiment, the method allows training the same neural network to identify properties describing the digital behavior and properties describing the digital environment, which improves the reliability as well as the accuracy of the identification of the digital use.

In one particular embodiment, the first set of primary training data and the first set of secondary training data comprise, for each packet of the first and second plurality of network packets, at least one training data among the following training data:
the size of the packet,
a duration between receiving or sending the packet and receiving or sending a previous packet of the same session or of the same protocol as said packet,
a source port of the packet,
a destination port of the packet,
a direction of the packet, and
a protocol of a higher-level layer in the packet under the OSI (Open Systems Interconnection) model.

The method allows training the same neural network to identify a digital use from training data that do not depend on the location or the time of the use, which improves the reliability of the identification of the digital use. Furthermore, the method does not use personal data, which allows protecting the privacy of the users. Indeed, the training data listed in the set of training data are not personal data, unlike other data of the network packets, such as the IP address.

In one particular embodiment, the primary training is reiterated for at least a second set of training data associated with a second set of target property values describing a second digital use.

In one embodiment, the secondary training is reiterated for at least a second target value of a target property.

In one particular embodiment, the primary training uses a multitask learning.

In one particular embodiment, obtaining said first set of primary training data and obtaining said first set of secondary training data each comprise the following steps:
obtaining a subset of network packets and, for each network packet of said subset:
obtaining a set of data of the network packet, and
processing said set of data of the network packet,
   so as to obtain the first set of training data,
   the processing step comprising:
for each data of said set of data of the network packet taking the form of a categorical variable, the conversion of the value into a vector of binary values, and
for each data of said set of data of the network packet having a numerical value set in an interval different from the interval comprised between 0 and 1, the normalization of the value so that it is set in the interval comprised between 0 and 1.

In one particular embodiment, the subset of network packets comprises a maximum of one hundred network packets.

In one particular embodiment, the method further comprises a step of filtering at least one network packet which is not associated with an operation implemented by a user at the application level.

The invention further relates to an artificial neural network trained by the training method as described above.

In one particular embodiment, the device is a network gateway.

In addition, the invention relates to a device comprising an artificial neural network as described above.

Furthermore, the invention relates to a method for using the artificial neural network as described above, to identify at least one value of a property among a set of property values, said usage method comprising the following steps:
obtaining a set of data,
applying the set of usage data to the input of the artificial neural network, so as to identify the property value associated with the set of usage data, said identified property value being the one having the highest associated prediction score among the prediction scores of the other values of the same property.

In one embodiment, the usage method is used to identify a digital use, said usage data being obtained from a plurality of network packets.

In this embodiment, the digital use being identified by associating each value of each property associated with said digital use with a prediction score, the value of each property of the digital use being identified by determining the value of the property having the highest associated prediction score among the prediction scores of the other values of the same property, said digital use being described by each identified property value.

In one particular embodiment, the usage method is implemented by a home gateway, said plurality of network packets transiting over a communications network to which said home gateway is connected.

In one particular embodiment, the training method is also implemented by the home gateway. As a variant, the neural network is trained by another device and installed on the home gateway after its training.

In one particular embodiment, the usage method comprises a step of using the identified digital use, comprising at least one usage among the following usages:
recommendation of a personalized service to the user of a terminal as a function of the identified digital use,
monitoring of an undesirable use at the terminal,
optimization of the load distribution in the communication network,
recognition of a user of the communications network,
allocation of the internal resources of the device implementing said usage method.

In one particular embodiment, the different steps of the training method according to the invention are determined by computer program instructions.

In addition, in one particular embodiment, the different steps of the usage method according to the invention are determined by computer program instructions.

Consequently, the invention also relates to a first computer program, on a first information medium, this first program including instructions adapted to the implementation of the steps of a training method according to the invention.

The invention further relates to a second computer program, on a second information medium, this second program including instructions adapted to the implementation of the steps of a usage method according to the invention.

Each of these first and second programs can use any programming language, and be in the form of source code, object code or intermediate code between source code and object code, such as in a partially compiled form or in any other desirable form.

The invention also relates to a first computer-readable information medium, and including instructions from the first computer program as mentioned above.

The invention also relates to a second computer-readable information medium, and including instructions from the second computer program as mentioned above.

The first and second information media can be any entity or device capable of storing the program. For example, each of these media can include a storage means, such as a ROM, for example a CD ROM or a microelectronic circuit ROM, or a magnetic recording means, for example a hard disk.

On the other hand, each of these information media can be a transmissible medium such as an electrical or optical signal, which can be conveyed via an electrical or optical cable, by radio or by other means. Each of the programs according to the invention can be particularly downloaded from an Internet-type network.

Alternatively, each information medium may be an integrated circuit in which the program is incorporated, the circuit being adapted to execute or to be used in the execution of the method in question.

### BRIEF DESCRIPTION OF THE DRAWINGS

Other characteristics and advantages of the present invention will become apparent from the description given below, with reference to the appended drawings which illustrate one exemplary embodiment devoid of any limitation. In the figures:

FIG. 1 schematically represents a training system according to one exemplary embodiment of the invention;

FIG. 2 schematically represents one example of architecture of the training system of FIG. 1;

FIG. 3 represents, in the form of a flowchart, the main steps of a training method according to one exemplary embodiment of the invention;

FIG. 4A schematically represents one example of a network trace that can be obtained during the implementation of the method of FIG. 3;

FIG. 4B schematically represents another view of the network trace of FIG. 4A;

FIG. 5 schematically represents one example of a neural network structure that can be defined when implementing the method of FIG. 3;

FIG. 6 represents, in the form of a flowchart, the main steps of a usage method according to one exemplary embodiment of the invention;

FIG. 7 schematically represents one example of a first target digital use that can be used when implementing the method of FIG. 3; and

FIG. 8 represents an extract of a confusion matrix that can be used in one embodiment of the invention.

### DESCRIPTION OF THE EMBODIMENTS

The present invention relates in particular to a method for training an artificial neural network so that said artificial neural network identifies a property value among a plurality of property values.

This training method includes a primary training and at least one secondary training. The secondary training is performed after the primary training and can also be referred to as post-training.

The detailed description is placed in the context in which the neural network is configured to detect a digital use among a set of digital uses.

Each digital use comprises a digital behavior and a digital environment, and is associated with a plurality of technical properties whose values describe the digital use, each property being able to take at least two different values.

More specifically, the value of at least one property of the plurality of properties allows describing or qualifying the digital behavior of the digital use, and the value of at least one other property of the plurality of properties allows describing or qualifying the digital environment of the digital use.

In general, the digital behavior can include the set of the data related to the execution of an application. The used property(ies) describing a digital behavior is(are) typically a used application category, a used application, an operation implemented at the application level and/or a user interaction state.

By “Application” it is meant a software installed locally on the used device, or an independent software (of the standalone application type), or a web application (or Website) which is accessed by a browser.

The interaction state indicates whether the user interacts with the used application, i.e. whether he implements an operation at the application level. The interaction state thus takes a first value (typically “1”) when the user implements an operation at the used application level, or takes a second value (typically “0”) when the user does not implement an operation (the application being open without the user being active), or when no application is used.

In general, the digital environment can include all the hardware and software capabilities of the terminal that exchanges the stream or of the network. For example, the used property(ies) describing the digital environment is(are) typically a used device (for example a fixed or mobile terminal such as a personal computer, a tablet, a television or a smartphone), a used operating system (for example Windows 10, Ubuntu, Android, Mac or iOS), a used browser (for example Chrome, Firefox, Edge, Safari or Opera), and/or at least one characteristic linked to a communication network, for example an Internet connection speed (for example an uplink connection speed and/or a downlink connection speed) or a latency.

The properties “uplink connection speed” and “downlink connection speed” can for example each take four values as a function of the measured speed, typically a first value for a measured speed greater than 1 Mbps (Megabit per second), a second value for a speed comprised between 1 and 10 Mbps, a third value for a speed comprised between 10 and 100 Mbps, and a fourth value for a speed greater than 1 Gbps (Gigabit per second).

The property “latency” can for example each take six values, for example <1 ms, 1-10 ms, 10-100 ms, 100-1,000 ms, 1-10 s, >10 s.

Each digital use of the set of digital uses is thus typically associated with at least two properties among the following properties (typically all of the following properties): the used application category, the used application, the operation implemented at the application level, the user interaction state, the used device, the used operating system, the uplink connection speed, the downlink connection speed and, when the application is a web application, the used browser. Each digital use differs from another digital use by the value of at least one of these properties.

The table 1 below lists examples of values that the property “used application category” can take, and for each application category value, examples of values that the properties “used applications” and “operation implemented at the application level” can take.

TABLE 1

| APPLICATION | | |
|---|---|---|
| CATEGORIES | APPLICATIONS | OPERATIONS |
| VideoStreaming | Youtube | Connection |
| | Dailymotion | BrowseRandomClick |
| | Twitch | BrowseKeywordSearch |
| | Mixer | PlayContent |
| | Caffeine | LikeCommentShare |
| | Monolov TV | SubscribeUnsubscribe |
| | Orange TV | PublishContent |
| | Peloton | |
| | Orange VoD | |
| | Netflix | |
| | Hulu | |
| | Disney+ | |
| | Amazon Prime Video | |
| | HBO Max | |
| | CBS All Access | |
| | AfreecaTV | |
| | NAVER | |
| SearchEngine | Google | Connection |
| | Bing | BrowseRandomClick |
| | DuckDuckGo | BrowseKeywordSearch |
| | Baidu | ClickSearchResult |
| | Yahoo | MapSearch |
| | Yandex | MapBrowse |
| | Ask | ImageSearch |
| | | Image Browse |
| InfoSites | Yahoo | Connection |
| | Orange | BrowseRandomClick |
| | Reddit | BrowseKeywordSearch |
| | Wikipedia | PlayContent |
| | Sohu | |
| | 360 | |
| | Sina | |
| | Okezone | |
| | CSDN | |
| | StackOverFlow | |
| | Worldometers | |
| | Word Press | |
| Gaming | LeagueOfLegend | Connection |
| | PlayerUnknown | PlayGame |
| | WorldOfWarcraft | BrowseRandomClick |
| | AddictingGames | BrowseKeywordSearch |
| | Pogo | DownloadGame |
| | Miniclip | |
| | Steam | |
| | GOG | |
| | PlayerUnknown's | |
| | Battlegrounds | |
| | Fortnite Battle Royale | |
| | Call of Duty | |
| | Roblox | |
| | WarThunder | |
| | Minecraft | |
| | Overwatch | |
| | Warframe | |
| | OrangeJeux | |
| Social | Facebook | Connection |
| | LinkedIn | BrowseRandomClick |
| | Twitter | Messaging |
| | Pinterest | Networking |
| | Instagram | PublishContent |
| | Weibo | LikeCommentShare |
| | Snpachat | |
| | TikTok | |
| | VK | |
| | ODNOKLASSNIKI | |
| Messaging | Skype | Connection |
| | Whatsapp | BrowseRandomClick |
| | LINE | BrowseKeywordSearch |
| | WeChat | Messaging |
| | QQ | VoiceCall |
| | Discord | VideoCall |
| | Signal | |
| | Facebook Messenger | |
| | WEBRTC | |
| | Gmail | |
| | Hotmail | |
| | Thunderbird | |
| | Outlook | |
| | Zoom | |
| | Microsoft Teams | |
| | Webex | |
| | GoToMeeting | |
| | MailOrange | |
| FileSharing | DropBox | Connection |
| | GoogleDrive | BrowseRandomClick |
| | iCloud | BrowseKeywordSearch |
| | Samsung | DownloadContent |
| | Samsung Cloud | UploadContent |
| | SharePoint | |
| | FileZila(FTP) | |
| | WinSCP(FTP) | |
| | uTorrent(BT) | |
| | bitTorrent(BT) | |
| | AppStore | |
| | GooglePlay | |
| | Microsoft Store | |
| AudioStreaming | Spotify | Connection |
| | Deezer | BrowseRandomClick |
| | Pandora | BrowseKeywordSearch |
| | ShoutCast | PlayAudio |
| | BBCRadio | LikeCommentShare |
| | OrangeRadio | SubscribeUnsubscribe |
| | Podcasts | |
| MarketPlace | Amazon | Connection |
| | Ebay | BrowseRandomClick |
| | Aliexpress | BrowseKeywordSearch |
| | Tabao | Add Favorite |
| | Alibaba | |
| | JD | |

For the property “application category”:
the value “VideoStreaming” indicates that the used application is a video file streaming application,
the value “SearchEngine” indicates that the used application is a search engine,
the value “InfoSites” indicates that the used application is an information application,
the value “Gaming” indicates that the used application is a game,
the value “Social” indicates that the used application is a social network,
the value “Messaging” indicates that the used application is a message call and/or sending application,
the value “FileSharing” indicates that the used application is a file sharing application,
the value “AudioStreaming” indicates that the used application is an audio file streaming application, and
the value “MarketPlace” indicates that the used application is an e-commerce application.

For the property “operation”:
the value “Connection” indicates that the user connects to a Website or an application,
the value “BrowseRandomClick” indicates that the user clicks on an internal link, that is to say a hypertext link located on an application (for example a webpage) and redirecting to another page or resource, for example an image or a document, on the same Website,
the value “BrowseKeywordSearch” indicates that the user searches for the result of a word in an application search bar,
the value “PlayContent” indicates that the user watches a video for 15 seconds,
the value “PlayGame” indicates that the user plays a game for 30 seconds,
the value “PlayAudio” indicates that the user listens to an audio document for 15 seconds,
the value “LikeCommentShare” indicates that the user likes, comments or shares a video element, an audio element or a message, unless the sharing redirects to another application,
the value “SubscribeUnsubscribe” indicates that the user subscribes to or unsubscribes from a channel,
the value “PublishContent” indicates that the user uploads a video or a file to a server for 15 seconds,
the value “DownloadContent” indicates that the user downloads a video or a file for 15 seconds,
the value “ClickSearchResult” indicates that the user clicks on a random link given by a results page of a search engine,
the value “ImageSearch” indicates that the user searches for the result of a given word provided by an image search engine,
the value “ImageBrowse” indicates that the user clicks on a random link provided by a results page of an image search engine,
the value “MapSearch” indicates that the user searches for the result of a word on the search bar of an online mapping of a search engine,
the value “MapBrowse” indicates that the user zooms in, zooms out, clicks on an element of the map, or modifies the display on an online mapping of a search engine (“switches to streetView”),
the value “Networking” indicates that the user requests to add a friend or join a group,
the value “Messaging” indicates that the user sends or receives a message or an email,
the value “AddFavorite” indicates that the user adds an object to a wishlist,
the value “VoiceCall” indicates that the user makes an audio call for 15 seconds, and
the value “VideoCall” indicates that the user makes a video call for 15 seconds.

The artificial neural network identifies a digital use by associating each value of each property associated with the digital uses with a prediction score.

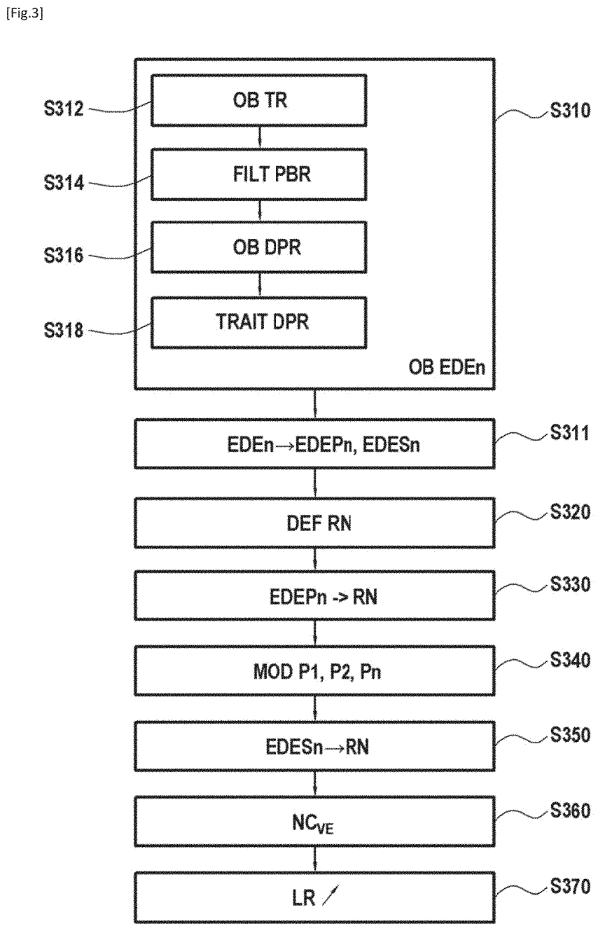

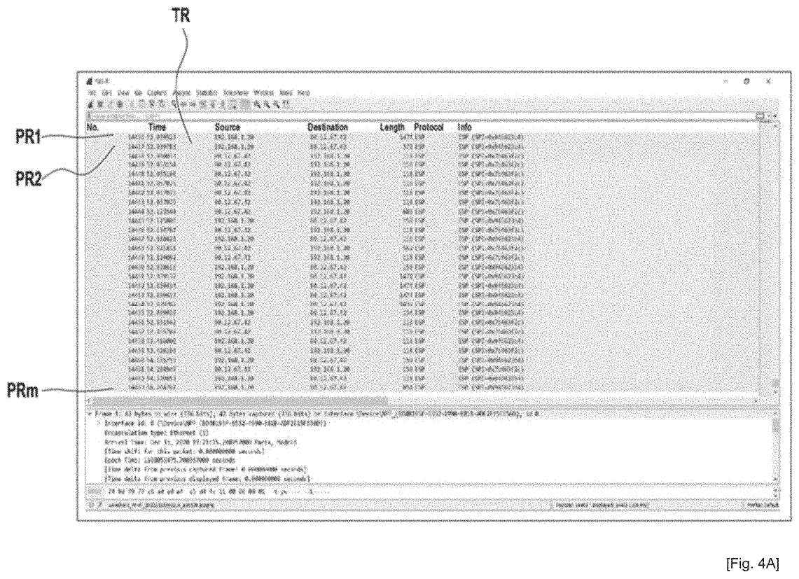

FIG. 1 schematically represents a training system 100 according to one exemplary embodiment of the invention, said training system 100 being able to implement a method for training an artificial neural network according to one exemplary embodiment of the invention, typically the method described below with reference to FIG. 3.

The training system 100 comprises a first obtaining module 110, a first application module 120 and a modification module 130.

The first obtaining module 110 is configured to obtain a set of primary training data and a set of secondary training data from a plurality of network packets, the set of these primary and secondary training data being associated with a set of target property values describing a target digital use.

Furthermore, the first application module 120 is configured to apply the set of primary training data (to perform a primary training) or the set of secondary training data (to perform a secondary training) at the input of the artificial neural network, the artificial neural network delivering as output a prediction score for each value of each property of the plurality of properties describing each digital use.

In addition, the modification module 130 is configured to modify at least one weight of the artificial neural network as a function of the set of target property values and of the prediction scores obtained by the first application module 120.

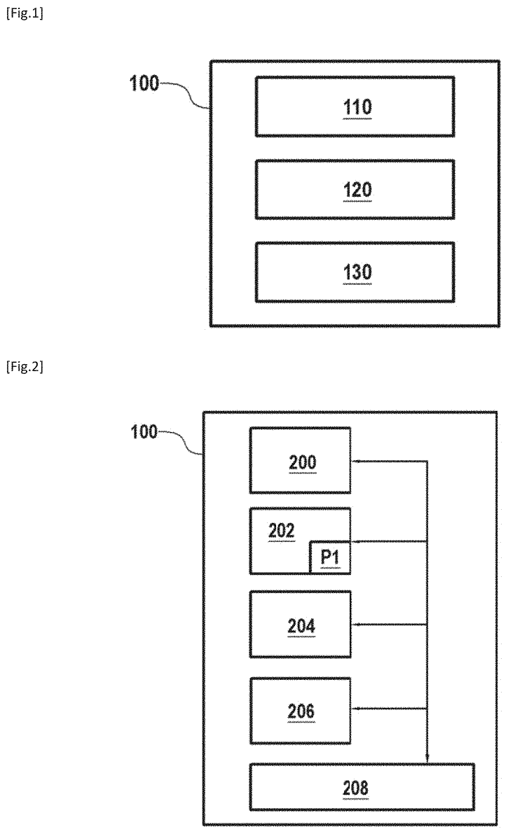

As shown in FIG. 2, the training system 100 comprises in particular a processor 200, a read-only memory 202 (of the ROM type), a rewritable non-volatile memory 204 (of the EEPROM or “Flash NAND type for example), a rewritable volatile memory 206 (of the RAM type), and a communication interface 208.

The read-only memory 202 constitutes a recording medium in accordance with one exemplary embodiment of the invention, readable by the processor 200 and on which a first computer program P1 in accordance with one exemplary embodiment of the invention is recorded. As a variant, the first computer program P1 is stored in rewritable non-volatile memory 204.

The first computer program P1 allows the training system 100 to implement a training method in accordance with the invention.

This first computer program P1 can thus define functional and software modules of the training system 100, configured to implement the steps of a training method in accordance with one exemplary embodiment of the invention. These functional modules are based on or control the hardware elements 200, 202, 204, 206 and 208 of the training system 100 mentioned above. They may comprise in particular here the first obtaining module 110, the first application module 120 and the modification module 130 mentioned above.

The training system 100 can be a terminal 100 (such as a network gateway) comprising the hardware elements 200, 202, 204, 206 and 208, as well as the modules 110, 120 and 130 mentioned above. As a variant, the training system can comprise several entities each having the conventional architecture of a computer, such as a terminal and one or several servers, the aforementioned modules 110, 120 and 130 then being distributed between these different entities.

FIG. 3 represents a training method in accordance with one exemplary embodiment of the invention. This method is implemented by a training system in accordance with one exemplary embodiment of the invention, such as for example the training system 100 described with reference to FIGS. 1 and 2.

In a step S310, the first obtaining module 110 obtains a first set of training data EDE1 from a plurality of network packets, said first set of training data EDE1 being associated with a first set of target property values describing a first target digital use UNC1.

In the embodiment described here, the plurality of first set of training data EDE1 is intended to be partitioned, during a step S311, into:
a first set of primary training data EDEP1 obtained from a first subset of the plurality of network packets; and
a first set of secondary training data EDES1 obtained from a second subset of the plurality of network packets.

As will be described later:
the first set of primary training data EDEP1 allows, during a primary training, training the artificial neural network RN to identify the first target digital use UNC1;
the first set of secondary training data EDES1 allows, during a secondary training (or post training), identifying weaknesses of the trained model during the first training (that is to say the property values which are misidentified by this model) and, by using targeted data and an adapted learning rate, reinforcing the model by a secondary training.

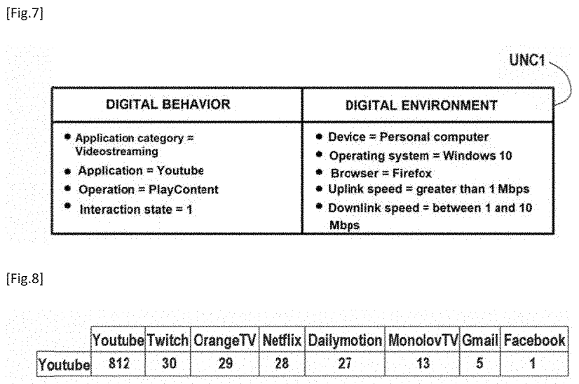

FIG. 7 illustrates one example of a first set of target property values describing the first target digital use UNC1, this first set comprising the following values:
the value “Videostreaming” for the property “used application category”,
the value “Youtube” for the property “used application”,
the value “Playcontent” for the property “operation implemented at the application level used”,
the value “1” for the property “interaction state”,
the value “personal computer” for the property “used device”,
the value “Windows 10” for the property “used operating system”,
the value “Firefox” for the property “used browser”,
the value “greater than 1 Mbps” for the property “uplink speed”, and
the value “between 1 and 10 Mbps” for the property “downlink speed”.

More specifically, step S310 comprises a step S312 of obtaining a network trace TR comprising a plurality of network packets.

The network trace TR is typically obtained by using a capture software tool that allows capturing the network packets exchanged by the terminal on which this software tool is executed, for example the TShark or tcpdump software tool.

Each network packet obtained comprises a plurality of network data, such as for example a packet number, a time data for sending or receiving the packet (absolute or relative, relative to a reference packet such as the first captured packet), a source IP (Internet Protocol) address of the packet, a destination IP address of the packet, a size of the packet, a protocol name in the packet, etc.

In order to implement the first target digital use UNC1, the used application associated with the first target digital use is opened on the terminal so as to be executed on the terminal of a tester, then the capture of the network packets is launched with the software tool. The terminal is the used device associated with the first target digital use, this terminal executing the used operating system and, when the used application is a web application, the used browser is associated with the first target digital use UNC1.

Thus, in the example of a first target digital use UNC1 in FIG. 7, Youtube is opened in the Firefox browser of a personal computer with Windows 10 as operating system.

Then, when the first target digital use is associated with a user interaction state indicating that the user is interacting with the application associated with the first target digital use UNC1 (this interaction state thus being typically equal to 1), the operation associated with the first target digital use UNC1 is executed.

Also, in the example of a first target digital use UNC1 in FIG. 7, the playback of a video on Youtube is launched.

The capture of the network packets is typically stopped when all the network packets associated with the operation are sent by the terminal or received by the terminal. The capture is therefore for example stopped when the results of the operation are displayed by the terminal.

For a duration typically comprised between 5 and 10 seconds of capture, the network trace TR obtained typically comprises between 100 and 1000 network packets for a search operation for the result of a word in a search bar (BrowseKeywordSearch), and typically comprises between 2,000 and 3,000 network packets for a video viewing operation (PlayContent).

The obtained network packets, which constitute the obtained network trace TR, are then recorded in association with the property values associated with the first target digital use UNC1, typically in the rewritable non-volatile memory 204.

The obtained network packets are thus labeled (the property values being called “labels”).

In order to obtain the value of the property “uplink connection speed” and/or the value of the property “downlink connection speed” associated with the first target digital use UNC1, a software tool can be used, such as the “Solarwinds Real—Time Bandwidth Monitor” or “Okala speedtest” tool, during the step S312 of obtaining the network trace TR, this software tool thus being used in parallel with the capture software tool. Capture software functions can allow determining the speed or the latency of packets within a stream by analyzing the trace captured at the end of capture of the stream.

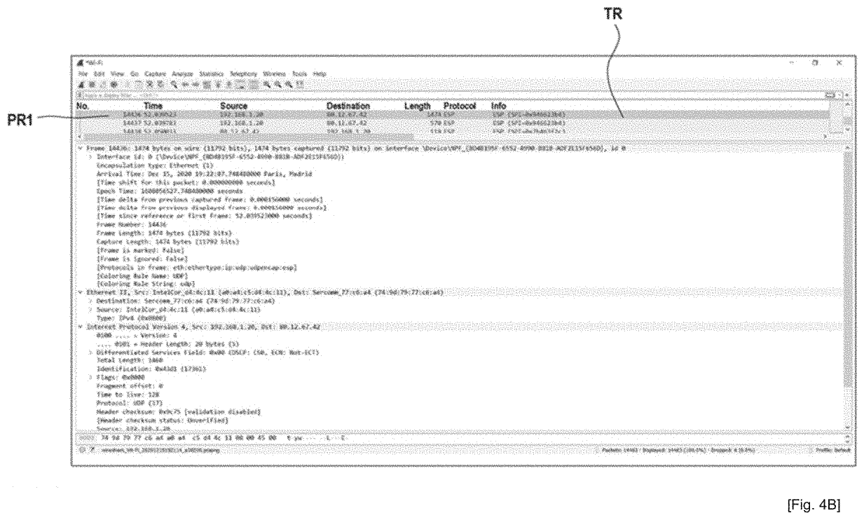

FIGS. 4A and 4B show one example of a network trace TR that can be obtained in the obtaining step S312. The network trace TR comprises a plurality of network packets PR1-PRm. Each network packet PR1-PRm comprising a plurality of data No (packet number), Time (time data for sending or receiving the packet), Source (source IP address of the packet), Destination (destination IP address of the packet), Length (memory size of the packet), Protocol (protocol name in the packet), and Info (other data of the packet).

In addition, when the first target digital use UNC1 is associated with a user interaction state indicating that the user is interacting with the application associated with the first target digital use UNC1 (this interaction state thus being typically equal to 1), it is useful to filter the network packets called background noise network packets PRB, which are not associated with an operation implemented by a user at the application level. Step S310 then typically comprises a step S314 of filtering at least one background noise network packet PRB.

When the operating system used is Linux, the filtering step is typically implemented during the step S312 of obtaining a network trace TR. A filtering software tool is launched before the capture software tool is launched, so as to be executed during the capture of the network packets. The filtering software tool used is for example Linux Network Namespace.

When the operating system used is not Linux (as in the example of FIG. 7), the filtering step is implemented after step S312 and typically comprises a step of obtaining a new network trace associated with a digital use for which the interaction state property indicates that the user is not interacting (this interaction state thus being typically equal to 0). This digital use is not associated with properties describing a digital behavior, and is typically only associated with the properties of the used device, the used operating system, the used browser and the interaction state, the used device being the terminal on which the capture software tool is executed and the same terminal making it possible to obtain the network trace TR associated with the first target digital use UNC1 in step S310, the operating system and/or the browser being the same as the operating system and/or the browser making it possible to obtain the network trace TR associated with the first target digital use UNC1 (different from linux) and the interaction state being typically equal to 0.

The capture of the network packets is launched with the capture software tool, for a predetermined duration, typically comprised between 10 and 100 hours.

A triplet of network data is then extracted from each packet obtained, said triplet of data comprising for example the source IP address of the packet, the destination IP address of the packet and the highest level protocol in the packet. A set of triplet of network data is thus obtained.

Each packet of the network trace TR associated with the first target digital use UNC1 obtained in step S312 comprising one of the triplets of data of the set of triplets of data obtained is then deleted, this packet being a background noise network packet PRB.

Step S310 comprises, for each network packet of a subset of network packets of the network trace TR obtained in step S312, a step S316 of obtaining a set of data in the network packet DPR, these data DPR then being intended to be divided (in step S311) into two sub-parts used respectively to provide the inputs of the artificial neural network RN during the primary training and during the secondary training.

The subset of network packets typically comprises a number P of first received and/or sent network packets of the network trace TR, and possibly not having been filtered in step S314, typically the first two hundred network packets PR, the data of one hundred packets being intended to be used for the primary training and the data of another hundred packets being intended to be used for the secondary training. This value of one hundred network packets allows a good compromise between calculation time and accuracy of the identification.

The data DPR of the set of data of the network packet DPR are typically selected so as to improve the reliability and the accuracy of the identification of the digital use (for example because they do not depend on the location or on the time of use) and/or protect the privacy of the users.

The set of data in the network packet DPR comprises several data DPR among the following data, typically all of the following data:
the size of the packet,
a duration between receiving or sending the packet and receiving or sending a previous packet of the same session or of the same protocol as said packet,
a source port of the packet,
a destination port of the packet,
a direction of the packet, i.e. whether the packet is received or sent, and
a protocol of a higher level layer in the packet.

The packet comprises the size, source port, destination port and higher level protocol data, and these data can thus be directly extracted from the packet.

The direction data of the packet is typically obtained from the source or destination MAC address. Indeed, when the packet is received (incoming packet), the destination MAC address is the MAC address of the device used, and when the packet is sent (outgoing packet), the source MAC address of the packet is the MAC address of the device used.

The duration data is typically calculated as a function of the packet sending or receiving time data. When the packet belongs to a session (typically a TCP or UDP session), the previous packet of the same session is identified and the duration data of the packet is subtracted from the duration data of the previous packet. When the packet does not belong to a session, the previous packet of the same protocol and not belonging to a session is identified, and the duration data of the packet is subtracted from the duration data of this previous packet.

Step S310 further comprises a step S318 of processing the sets of data of the network packets DPR obtained in step S316, so as to obtain the first set of training data EDE1.

Step S318 comprises, for each data DPR from each set of data of the network packet DPR having a name as a value (i.e. taking the form of a categorical variable), a conversion of the value of said data DPR into a vector of binary values (binary variables).

A categorical variable typically takes the form of a character string comprising letters and/or numbers, whose value is a name. For example, the number of a port is a categorical variable, the number naming (referencing) the port but not involving a relationship of superiority relative to a smaller port number.

The vector comprises a number of binary values equal to the number of values that said data DPR can take, each binary value corresponding to one of the name values, and being set to 1 for the name value actually taken by the data, and to 0 for the others (technique called “one-hot” coding technique). This conversion is typically implemented for the source port, destination port and higher level protocol data.

As a variant, another binarization method can be used, such as for example one of the methods called “simple coding”, “deviation coding”, “orthogonal polynomial coding”, “Helmert coding”, “reverse Helmert coding”, “forward difference coding”, “backward difference coding” and “user-defined coding”, for example described on the webpage https://stats.idre.ucla.edu/r/library/r-library-contrast-coding-systems-for-categorical-variables/.

Furthermore, step S318 comprises, for example, for each data DPR of each set of data of the network packet DPR having a numerical value set in an interval different from the interval comprised between 0 and 1, a normalization of the value so that it is set in the interval comprised between 0 and 1. All the data DPR are then on the same scale, which allows accelerating the training of the artificial neural network RN. The normalization is typically implemented for the size and duration data.

The method called “min-max normalization” is for example used for the normalization, the used formula then being:

$${x}^{′} = \frac{x - min ( x )}{max ( x ) - min ( x )} \qquad [ Math . 1 ]$$

where x represents the value to normalize, x′ represents the normalized value, max(x) represents the maximum value that the value to normalize can take and min(x) represents the minimum value that the value to normalize can take.

In the embodiment described here, the first set of training data EDE1 is divided into two sets, in step S311, namely a first set of primary training data EDEP1 and a first set of secondary training data (or post-training) EDES1. Each of these first sets represents for example 50% of the first set of training data EDE1.

In a step S320, the structure of the artificial neural network RN is defined.

The structure used to define the neural network is for example the structure called “forward propagation neural network”. The neural network comprises an input layer, an output layer and one or several hidden layers, each layer comprising a plurality of neurons, also called neurons.

Furthermore, each hidden layer, as well as the output layer, are each associated with a mathematical operation, also called activation function, performed at each neuron of said layer.

In addition, each neuron of a hidden layer and of the output layer is “connected” to each neuron of the previous layer by a weight, each neuron thus taking as input the result (or the value, for the input layer) of each neuron of the previous layer multiplied by the associated weight, i.e. the weight linking said neuron to said neuron of the previous layer.

The number of layers is typically defined in step S320, as well as the activation functions and the number of neurons of the hidden and output layers.

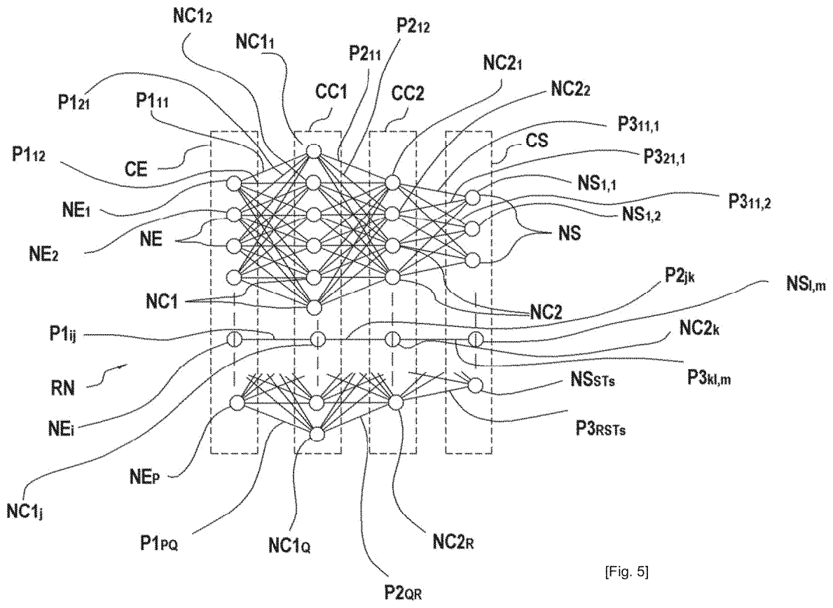

The artificial neural network RN defined typically comprises 4 layers of artificial neurons, an input layer CE, an output layer CS, a first hidden layer CC1 and a second hidden layer CC2, the first hidden layer CC1 being positioned between the input layer CE and the second hidden layer CC2, and the second hidden layer CC2 being positioned between the first hidden layer CC1 and the output layer CS. FIG. 5 schematically represents one example of such an artificial neural network RN.

Each layer CE, CC1, CC2 and CS comprises a plurality of neurons NE, NC1, NC2, NS (neurons). In addition, the first hidden layer CC1, the second hidden layer CC2 and the output layer CS are each associated with a mathematical operation.

The first mathematical operation (or first activation function) associated with the first intermediate layer CC1 is performed at each neuron NC1 of the first intermediate layer CC1, each mathematical operation at a neuron NC1 being performed as a function of each value of each input neuron NE, each of its values being weighted by a weight P1, which may differ from one value to another. The set of the weights P1 assigned to the values of the input neurons NE is typically randomly initialized.

The first mathematical operation performed is typically the application of the hyperbolic tangent function to the sum of each weighted value of each input neuron NE, the hyperbolic tangent function being denoted tanh, and can be defined by the following mathematical formula, for the neuron NC1ⱼ of the first hidden layer CC1, j belonging to the interval [1, Q], where Q is the number of neurons of the first hidden layer CC1, for example equal to 2,500:

$$tanh ( {y}_{j} ) = \frac{{e}^{{y}_{j}} - {e}^{- {y}_{j}}}{{e}^{{y}_{j}} + {e}^{- {y}_{j}}} \qquad [ Math . 2 ]$$

where yⱼ represents the sum of the weighted values of the input neurons NE, with:

$${y}_{j} = {\sum }_{i = 1}^{P} N {E}_{i} \times P {1}_{i j} \qquad [ Math . 3 ]$$

where i belongs to the interval [1, P], P being the number of neurons of the input layer CE, P1ᵢⱼ thus being the weight P1 linking the neuron NEᵢ of the input layer to the neuron NC1ⱼ of the first hidden layer CC1.

In addition, the second mathematical operation (or second activation function) associated with the second intermediate layer CC2 is performed at each neuron NC2 of the second intermediate layer CC2, each mathematical operation at a neuron NC2 being performed as a function of the result of each first operation performed at each neuron NC1 of the first intermediate layer CC1, each of its results being weighted by a weight P2, which may differ from one value to another. The set of the weights P2 assigned to the results of the neurons NC1 of the first hidden layer CC1 is typically randomly initialized.

The second mathematical operation performed is typically the application of the Rectified Linear Unit function to the sum of each weighted result of each neuron NC1 of the first intermediate layer CC1, the Rectified Linear Unit function being denoted ReLu, and can be defined by the following mathematical formula, for the neuron NC2ₖ of the second hidden layer CC2, k belonging to the interval [1, R], where R is the number of neurons of the first hidden layer, for example equal to 750:

ReLu(zₖ)=max(0,zₖ) [Math. 4]

where zₖ represents the sum of the weighted results of the neurons NC1 of the first intermediate layer CC1, with:

$${z}_{k} = {\sum }_{j = 1}^{Q} tanh ( {y}_{j} ) \times P {2}_{j k} \qquad [ Math . 5 ]$$

where j belongs to the interval [1, Q], Q being the number of neurons of the first hidden layer CC1, P2ⱼₖ thus being the weight P2 linking the neuron NC1ⱼ of the first hidden layer CC1 to the neuron NC2ₖ of the second hidden layer CC2.

Furthermore, the third mathematical operation (or third activation function) associated with the output layer CS is performed at each neuron NS of the output layer CS, each mathematical operation at a neuron NS being performed as a function of the result of each second operation performed at each neuron NC2 of the second intermediate layer CC2, each of its results being weighted by a weight P3, which may differ from one value to another. The set of the weights P3 assigned to the results of the neurons NC2 of the second intermediate layer CC2 is typically randomly initialized.

The result of each third mathematical operation performed at a neuron NS of the output layer CS corresponds to a prediction score of a value of a property of the plurality of properties describing each digital use of the set of digital uses. A probability rate is thus associated with each value of each property of the plurality of properties at the output of the artificial neural network, and thus typically with each value of application category used, of application used, of operation implemented at the application level, of user interaction state, of device used, of operating system used and, when the application is a web application, of browser used.

The third mathematical operation is typically the application of the softmax function, also called normalized exponential function, to the sum of the weighted results of the neurons NC2 of the second intermediate layer CC2, the softmax function being defined by the following formula, for the neuron NS_{I,m}, where I belongs to the interval [1, S], where S is the number of properties of the plurality of properties whose values describe the digital uses, and m∈[1, T₁], where T₁ is the number of values that the property I can take, the neuron NS_{I,m} thus being the neuron associated with the value m of the property I:

$${σ ( b )}_{l , m} = \frac{{e}^{{b}_{l , m}}}{{\sum }_{n = 1}^{{T}_{l}} {e}^{{b}_{l , n}}} \qquad [ Math . 6 ]$$

where b_{1,m} represents the sum of the weighted results of the neurons NC2 of the second intermediate layer CC2, with:

$${b}_{l , m} = {\sum }_{k = 1}^{R} R e L u ( {z}_{k} ) \times P {3}_{k l , m} \qquad [ Math . 7 ]$$

where k belongs to the interval [1, R], R being the number of neurons NC2 of the second hidden layer CC2, P3_{kI,m} thus being the weight P3 linking the neuron NC2ₖ of the second hidden layer CC2 to the neuron NS_{I,m} of the output layer CS.

One example of a primary training that can be implemented in one embodiment of the invention will now be described.

This primary training is performed by using the first set of primary training data EDEP1 obtained in step S311.

In the embodiment described here, the first set of primary training data EDEP1 is divided into 3 subsets, namely:
a first subset EDEP1_{E} for the primary training per se;
a second sub-assembly EDEP1_{V} to validate the primary training; and
a third sub-assembly EDEP1_{T} to test the primary training.

In the embodiment described here, the first, second and third subsets EDEP1_{E}, EDEP1_{V}, EDEP1_{T} represent approximately 80%, 10% and 10% of the first set of primary training data EDEP1.

In a step S330, the first subset of the first set of primary training data EDEP1_{E} is applied, by the first application module 120, to the input CE of the artificial neural network RN.

More specifically, each training data of the first subset of the first set of primary training data EDEP1_{E} corresponds to one or several neurons NE of the input layer CE. When the value of the training data takes the form of a vector of binary values, the number of neurons NE of the input layer CE corresponding to said training data is equal to the number of binary values of the vector, and each neuron NE then takes the value of one of the binary values of the vector. When the training data comprises a single value, a single neuron NE of the input layer CE corresponds to the training data, and thus takes the value of the training data.

The number of neurons NE of the input layer CE is thus greater than or equal to the number of training data of the first set of training data EDE1.

The first, second and third mathematical operations are then applied by using the first subset from the first set of primary training data EDEP1_{E}, respectively in the first hidden layer CC1, the second hidden layer CC2 and the output layer CS.

The artificial neural network RN then outputs a prediction score for each value of each property of the plurality of properties describing each digital use.

In a step S340, at least one weight P1, P2 or P3 of the artificial neural network NR is modified, by the modification module 130, as a function of the first set of target property values and of the prediction scores obtained in step S330.

The weight(s) P1, P2, P3 are typically modified according to a gradient backpropagation method.

More specifically, as indicated previously, each value of each property of the plurality of properties describing the digital use is associated with a neuron NS different from the output layer CS, the neuron delivering a prediction score for this value.

The first set of target property values describing the first target digital use UNC1 allows assigning each neuron NS of the output layer CS an expected score, the score being high for each neuron NS associated with a target value of the first set of target values (for example 100%) and being lower for each neuron NS associated with a value other than a target value (for example 0%).

Each prediction score delivered by a neuron NS of the output layer CS is thus compared with the expected value associated with said neuron NS, the difference EP between the prediction score and the expected value (called error EP associated with said neuron NS) then being used to modify each weight linking said neuron to a neuron NC2 of the second hidden layer CC2. The following formula to calculate the new value of the weight P3k_{I,m+1} linking the neuron NC2ₖ of the second hidden layer CC2 to the neuron NS_{I,m} of the output layer CS is typically used:

$$P {3}_{k l , m} + 1 = P {3}_{k l , m} - L R \frac{\partial ( E {P}_{l , m}^{2} )}{\partial ( P {3}_{kl , m} )} \qquad [ Math . 8 ]$$

where P3_{kI,m} is the current value of the weight linking the neuron NC2ₖ of the second hidden layer CC2 to the neuron NS_{I,m} of the output layer CS, LR is a constant equal to 0.01 representative of a learning rate, and EP_{I,m} is the difference EP between the prediction score and the expected value of the neuron NS_{I,m} of the output layer CS.

In order to calculate the weights P2 linking the neurons NC2 of the second hidden layer CC2 to the neurons NC1 of the first hidden layer CC1, the total contribution of each neuron NC2 of the second hidden layer CC2 to the errors associated with the neurons NS of the output layer CS is calculated.

The total contribution CT2ₖ of the neuron NC2ₖ to the errors associated with the neurons CS of the output layer NS is typically calculated by means of the following formula:

$$C T {2}_{k} = {\sum }_{l = 1}^{S} {\sum }_{m = 1}^{{T}_{S}} c t {2}_{kl , m} \qquad [ Math . 9 ]$$

where ct2_{kI,m} is the contribution of the neuron NC2ₖ of the second hidden layer CC2 to the error associated with the neuron NS_{I,m} of the output layer CS, typically calculated according to the following formula:

$$c t {2}_{kl , m} = \frac{P {3}_{kl , m}}{{\sum }_{k = 1}^{R} P {3}_{kl , m}} \times E {P}_{l , m} \qquad [ Math . 10 ]$$

where P3_{kI,m} is the weight P3 linking the neuron NC2ₖ of the second hidden layer CC2 to the neuron NS_{I,m} of the output layer CS and EP_{I,m} is the difference EP between the prediction score and the expected value of the neuron NS_{I,m} of the output layer CS.

The following formula to calculate the new value of the weight P2ⱼₖ₊1 linking the neuron NC1ⱼ of the first hidden layer CC1 to the neuron NC2ₖ of the second hidden layer CC2 can then be used:

$$P {2}_{j k} + 1 = P {2}_{j k} - L R \frac{\partial ( C T {2}_{k}^{2} )}{\partial ( P {2}_{j k} )} \qquad [ Math . 11 ]$$

where P2ⱼₖ is the current value of the weight linking the neuron NC1 of the first hidden layer CC1 to the neuron NC2ₖ of the second hidden layer CC2, LR is a constant corresponding to a learning rate equal to 0.01, and CT2ₖ is the total contribution of the neuron NC2ₖ to the errors associated with the neurons NS of the output layer.

The weights P1 linking the neurons NC1 of the first hidden layer CC1 to the neurons NE of the input layer CE are calculated in the same way as the weights P2 linking the neurons NC2 of the second hidden layer CC2 to the neurons NC1 of the first hidden layer CC1.

The primary training thus typically uses a multitask learning with a neural network RN delivering a prediction score for each value of each property and the use of the gradient backpropagation method.

The implementation of the step of obtaining S311 the first subset of the first set of primary training data EDEP1_{E}, the application S330 and modification S340 steps correspond to an iteration of the primary training of the artificial neural network NR. These obtaining S311, application S330 and modification S340 steps are typically reiterated one or several times, each iteration of these steps S330 and S340 using the neural network RN comprising the weights modified in the modification step S340 of the previous iteration.

During this primary training, the neural network NR is trained so that for each property, it associates a prediction score associated with the target value of the property (of the first set of target property values) greater than the prediction score of the other values of the same property.

During this primary training, the steps of obtaining S311 a first subset of the first set of primary training data EDEP1_{E}, applying S330 these primary training data and modifying S340 at least one weight can be reiterated one or several times for the first target digital use UNC1. Several network traces can thus be obtained for the first target digital use UNC1 and then be used to train the artificial neural network NR.

In addition, during this primary training, the steps of obtaining S311 a first subset of primary training data EDEP1_{E}, applying S330 these training data and modifying S340 at least one weight can be reiterated one or several times for each digital use of the set of digital uses, the first obtaining module 110 then obtaining an n^{th} subset of primary training data EDEPn_{E} which is applied by the first application module 120 at the input CE of the artificial neural network RN, and the modification module 130 modifying one or several weights of the neural network RN as a function of the n^{th} set of target property values corresponding to the n^{th} digital use and of the prediction scores obtained in this iteration of step S330.

When one or several network traces associated with a digital use for which the interaction state property indicates that the user is not interacting are obtained in one or several iterations of step S314, each network trace can also be used in a new iteration of the application S330 and modification S340 steps.

During this primary training, after the implementation of the obtaining S311, application S330 and modification S340 steps for the first digital use, these steps S311, S330 and S340 are typically reiterated for each other digital use of the set of digital uses, the weights P1, P2, P3 of the neural network RN being modified at each iteration and the weights thus modified being used at the following iteration.

The implementation of the obtaining S311, application S330 and modification S340 steps for each digital use of the set of digital uses is called complete learning cycle or period.

All the iterations of the obtaining steps S311 can be implemented before the implementation of the application step S330 for the first digital use.

The obtaining step can further be implemented one or several new times for each digital use of the plurality of digital uses in order to obtain one or several other sets of training data for each digital use of the plurality of digital uses, typically before the implementation of the application step S330 for the first digital use. The sets of data obtained are typically used during a validation or another complete learning cycle.

Following the implementation of a period, a validation of the primary training can be achieved by implementing the application S330 and modification S340 steps for each digital use in the set of digital uses, from the second subset EDEP1_{V} of the first set of primary training data for each digital use obtained at iterations of step S310 and not having been used yet. This validation allows evaluating the accuracy of the identification by the neural network NR.

More specifically, if, at the end of the validation, the accuracy of the identification (of the prediction) does not increase, the primary training is stopped. Otherwise, a new complete learning cycle and a new validation are carried out, and so on until the accuracy of the identification does not increase.

A final test can then be performed by implementing the application S330 and modification S340 steps for each digital use of the set of digital uses, from the third subset EDEP1_{T} of the first set of primary training data for each digital use obtained at iterations of step S310 and not having been used yet.

Once the primary training is completed, a secondary training (or post-training) is implemented in order to detect weaknesses of the model trained during the primary training and, to reinforce this model by using targeted data and an appropriate learning rate.

This secondary training will now be described.

This secondary training is performed by using the first set of secondary training data EDES1 obtained in step S311.

In the embodiment described here, the first set of secondary training data EDES1 is divided into 3 subsets, namely:
a first subset EDES1_{E} for the secondary training per se;
a second subset EDES1_{V} to validate the secondary training; and
a third subset EDES1_{T} to test the secondary training.

In the embodiment described here, the first, second and third subsets EDES1_{E}, EDES1_{V}, EDES1_{T} represent approximately 80%, 10% and 10% of the first set of secondary training data EDES1.

This secondary training can be performed for at least one target value VC of a target property PC.

During a step S350, a subset EDES1_{E,VC}, of data associated with a use whose property PC has this target value VC is extracted from the first subset EDES1_{E}.

The data of the subset EDES1_{E,VC}, are applied, by the first application module 120, to the input CE of the artificial neural network RN trained by the primary training to identify the estimated value VE of the property PC of an estimated digital use UNE for each of these data.

This estimated value VE is identified by associating with this value VE the value of the property PC having the highest prediction score among the prediction scores of the other values of the same property PC.

This step S350 thus allows evaluating the accuracy of the model of the neural network RN for the target value VC at the end of the primary training.

The results of this step S350 can be grouped together in a confusion matrix MC, each row of which corresponds to a target value VC and each column of which corresponds to an estimated value VE by the neural network for the target property PC of this target value VC.

One example of a row of such a confusion matrix is represented in FIG. 8 for the target value “Youtube” of the target property “Application”. In this example, 1,000 stream samples from Youtube have been classified, and the confusion matrix result MC for the target value “Youtube” after the evaluation is:
812 times the estimated value Youtube (correctly classified),
30 times the estimated value Twitch (misclassified),
29 times the estimated value OrangeTV (misclassified),
28 times the estimated value Netflix (misclassified),
27 times the estimated value Dailymotion (misclassified),
13 times the estimated value MonolovTV (misclassified),
5 times the estimated value Gmail (misclassified), and
1 time the estimated value Facebook (misclassified).

In the embodiment described here, the training method includes a step S360 of obtaining, for each target value VC of a target property, a number of confusions NC_{VE} corresponding to the number of times the same estimated value VE of said target property PC is different from the target value VC.

Thus in the example of FIG. 8, for the target value “Youtube” of the property “Application”, step S360 obtains:
30 confusions with the estimated value “Twitch”;
29 confusions with the estimated value “OrangeTV”;
28 confusions with the estimated value “Netflix”;
27 confusions with the estimated value “DailyMotion”;
13 confusions with the estimated value “MonolovTV”;
5 confusions with the estimated value “Gmail”;
1 confusion with the estimated value “Facebook”.

In the embodiment described here, during a step S370, for at least one target value VC (for example “Youtube”), a determined number (for example 5) of values of interest VI corresponding to the most misclassified estimated values VE in other words those for which the number of confusions is the greatest, is determined.

In the example described here, the values of interest for the target value “Youtube” are the values of interest “Twitch”, “Orange TV”, “Netflix”, “DailyMotion” and “MonolovTV”.

In the embodiment described here, during a step S370, the learning rates LR associated with the output neurons ND of the neural network RN associated with the values of interest VI are increased.

In the embodiment described here, this increase consists in increasing the parameter LR of the equations Math8 and Math11 for these output neurons.

For example, the learning rates are multiplied by 5. They then move to 0.05, the learning rates of the other output neurons remaining unchanged and equal to 0.01.

The modification of the learning rate of a neuron of a neural network is known to those skilled in the art. In particular, it can be performed by passing these modified learning rates LR as parameters of the backpropagation method implemented in the secondary training.

In the embodiment described here, the secondary training differs from the primary training:
in the choice of input data, these being associated with a chosen property value;
in the increase of the learning rates LR associated with the values of interest for this target value.

During this secondary training, the neural network NR can be trained in order to detect the prediction errors of each property value and modify the network so that it improves its ability to predict all the values of all the properties.

The secondary training can be reiterated several times for one or several property values.

Following the implementation of a period, a secondary training validation from the second subset EDES1_{V} for each property value. This validation allows evaluating the accuracy of the identification by the neural network NR at the end of the secondary training.

More specifically, if at the end of the validation, the accuracy of the identification (of the prediction) does not increase, the secondary training is stopped. Otherwise, the secondary training is continued with a new learning cycle and a new validation, and so on until the accuracy of the identification does not increase.

A final test can then be performed by using the third subset EDES1_{T}.

The artificial neural network RN trained following the implementation of the method of FIG. 3 is typically stored in the memory of a device such as a network gateway, a server or a fixed or mobile terminal such as a personal computer, a tablet, a television or a smartphone.

For example, the neural network RN is stored in the memory of a server of an Internet service provider infrastructure and allows analyzing the digital uses of the users of this Internet service.

The neural network RN can as a variant be stored in the memory of a network gateway in a network LAN (Local Area Network) and allows analyzing the digital uses of the users of this network LAN.

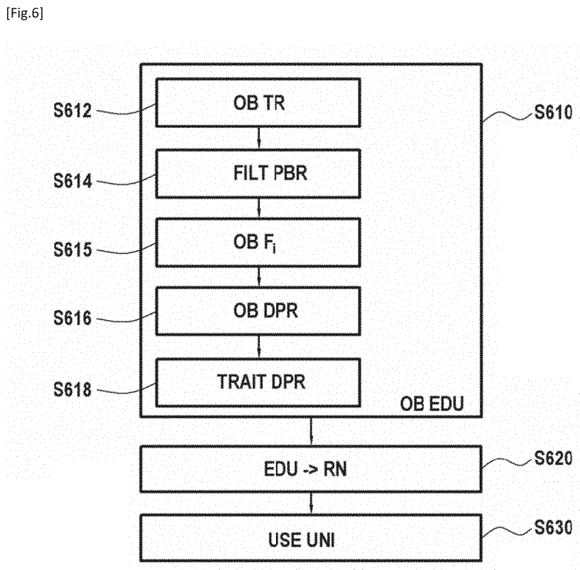

FIG. 6 represents a method for using the artificial neural network trained by the implementation of the method of FIG. 3, to identify a digital use among the set of digital uses, the usage method being compliant with one exemplary embodiment of the invention. This method is implemented by a device compliant with one exemplary embodiment of the invention, comprising the trained neural network RN.

The device comprises a second obtaining module and a second application module (which may be the first obtaining module 110 and the first application module 120 when the device is the terminal 100 having implemented the training method), and typically presents the conventional architecture of a computer. The device comprises in particular a processor, a read-only memory (of the ROM type), a rewritable non-volatile memory (of the EEPROM or Flash NAND type for example), a rewritable volatile memory (of the RAM type), and a communication interface.

The read-only memory or the rewritable non-volatile memory constitutes a recording medium in accordance with one exemplary embodiment of the invention, readable by the processor and on which a second computer program in accordance with one exemplary embodiment of the invention is recorded, allowing the device to implement the usage method in accordance with the invention.

This second computer program can thus define functional and software modules of the device, configured to implement the steps of a usage method in accordance with one exemplary embodiment of the invention. These functional modules are based on or control the hardware elements of the device mentioned above, and can comprise in particular here the second obtaining module and the second application module mentioned above.

In a step S610, a set of usage data EDU is obtained from a plurality of network packets by the second obtaining module.

This obtaining step S610 comprises a step of obtaining S612 a network trace TR comprising a plurality of network packets, typically by means of a capture software tool. The obtained network packets, which constitute the obtained network trace TR, are then recorded in the device. Unlike step S310 of the training method, the obtained network trace TR is not recorded in association with associated property values.

The obtaining step S610 also typically comprises a step of filtering S614 at least one background noise network packet PRB, this filtering step being implemented in the same way as the filtering step S314 of the training method of FIG. 3, but relative to the network trace TR obtained in step S612.

In addition, step S610 comprises, for each network packet of a subset of network packets of the network trace TR obtained in step S612, a step of obtaining S616 a set of data of the network packet DPR, this step being implemented in the same way as the step of obtaining S316 a set of data of the network packet of the training method of FIG. 3 but relative to the network trace TR obtained in step S612 and optionally filtered in step S614.

Step S310 further comprises a step of processing S618 the sets of network packet data obtained in step S616, so as to obtain the set of usage data. This processing step S618 is typically implemented in the same way as the processing step S318 of the training method of FIG. 3.

In a step S620, the set of usage data is applied to the input of the trained artificial neural network RN, so as to identify the digital use associated with the set of usage data.

The trained artificial neural network then outputs a prediction score for each value of each property of the plurality of properties describing each digital use.

The value of each property of the digital use is identified by determining the value of the property with the largest associated prediction score and/or higher than the prediction score of the other values of the same property.

The digital use is then described by each identified property value.

The usage method can further comprise a step S630 of using the identified digital use UNI.

Step S630 typically uses a plurality of identified digital uses UNI, each digital use UNI being identified during an implementation different from steps S610 and S620.

Step S630 comprises, for example, a recommendation of a personalized service to the user of a terminal according to the digital use(s) identified at this terminal. For example, an application similar to a used application (typically of the same category) can be recommended, and/or an application of category related to the category of the application used, and/or an application used by the users in the same digital environment or a similar digital environment, and/or an application with a high usage rate.

The device implementing the usage method is typically a network gateway (or home gateway), the plurality of network packets of the network trace TR obtained in step S610 transiting over a communications network to which said gateway is connected, typically a local communications network, to which at least one terminal is also connected.

The identified digital use(s) UNI can then typically have been carried out at one or several terminals of the local network (or even at all the terminals) and the step S630 can comprise an optimization of the load distribution in the communications network as a function of the digital use(s) UNI detected at these terminals.

For example, the network (i.e. the bandwidth) of the terminal can be dimensioned as a function of the digital use(s) UNI detected at these terminals.

As a variant or in addition, the use step S630 can comprise a recognition (or a detection) of a local communications network user, and possibly the loading of a profile of the user as a function of the digital use(s) UNI detected at the terminal.

As a variant or in addition, the use step S630 can comprise an allocation of the internal resources of the gateway as a function of the digital use(s) UNI detected at the terminal.

As a variant or in addition, the use step S630 can comprise an undesirable use monitoring at the terminal, as a function of the digital use(s) UNI detected at the terminal.

1. A computer-implemented training method for training an artificial neural network so that said artificial neural network identifies at least one value of a property among a plurality of property values, each property being able to take at least two different values, said artificial neural network including an output layer including, for at least one said property value, a neuron configured to deliver a prediction score for said property value;
said method comprising:
implementing a primary training comprising training said neural network to identify at least one target property value from a first set of primary training data labeled by associating these data with a first set of target property values;
implementing a secondary training including:
obtaining, for at least a first target value of a target property, a set of secondary training data;
identifying an estimated value of the target property associated with at least one said secondary training data, by using the artificial neural network trained by said primary training;
for each estimated value different from said first target value, obtaining a number of confusions corresponding to a number of times said estimated value has been estimated; and
increasing learning rates associated with said neurons of the output layer of said neural network that are associated with values of interest corresponding to estimated values with largest numbers of confusions.

2. The training method according to claim 1, wherein said artificial neural network is configured to identify a digital use among a set of digital uses, each digital use being described by a digital behavior associated with at least one said property and by a digital environment associated with at least one said property;
said primary training comprising training said neural network to identify at least one target digital use among said set of digital uses, the data of said first set of primary training data being extracted from a first plurality of network packets captured during at least one execution of an application associated with said first target digital use, said primary training data being labeled by associating these data with a first set of target property values describing at least a digital behavior and a digital environment of said first target digital use,
the data of said set of secondary training data obtained for said at least one first target value being extracted from a second plurality of network packets captured during at least one execution of an application associated with a digital use whose said target property is described by said first target value.

3. The training method according to claim 1, wherein, during said primary training, said learning rates associated with said neurons of the output layer of said neural network have the same value.

4. The training method according to claim 1, wherein said increase of one said learning rate comprises multiplying this learning rate by a constant.

5. The training method according to claim 1, wherein said primary training includes:
obtaining said first set of primary training data;
applying said first set of primary training data to an input of the artificial neural network, and
modifying at least one weight of the artificial neural network as a function of the first set of target property values and of the prediction scores obtained.

6. The training method according to claim 2, wherein the properties defining the digital use comprise at least one property among the following properties:
a used application category,
a used application,
an operation implemented at an application level,
a user interaction state,
a used device,
a used operating system,
a used browser, and
at least one related characteristic of a communication network.

7. The training method according to claim 2, wherein said first sets of primary and secondary training data comprise, for each packet of the first and second plurality of network packets, at least one training data among the following training data:
the size of the packet,
a duration between receiving or sending the packet and receiving or sending a previous packet of a same session or of a same protocol as said packet,
a source port of the packet,
a destination port of the packet,
a direction of the packet, and
a protocol of a higher-level layer in the packet.

8. The training method according to claim 1, wherein said primary training is reiterated for at least a second set of primary training data associated with a second set of target property values describing a second digital use.

9. The training method according to claim 1, wherein said secondary training is reiterated for at least a second target value of a target property.

10. The training method according to claim 1, wherein the primary training uses a multitask learning.

11. The training method according to claim 2, wherein obtaining said first set of primary training data and obtaining said first set of secondary training data each comprise the following steps:
obtaining a subset of network packets and, for each network packet of said subset:
obtaining a set of data of the network packet, and
processing said set of data of the network packet,
so as to obtain the first set of training data,
the processing comprising:
for each data of said set of data of the network packet taking the form of a categorical variable, converting the value into a vector of binary values, and
for each data of said set of data of the network packet having a numerical value set in an interval different from the interval comprised between 0 and 1, normalizing the value so that the value is set in the interval comprised between 0 and 1.

12. The training method according to claim 11, wherein the subset of network packets comprises a maximum of one hundred network packets.

13. The training method according to claim 2, further comprising filtering at least one network packet which is not associated with an operation implemented by a user at the application level.

14. A training system for training an artificial neural network so that said artificial neural network identifies at least one property value among a plurality of property values, each property being able to take at least two different values, the artificial neural network including an output layer including, for at least one said property value, a neuron configured to deliver a prediction score for said property value,
said system comprising:
at least one processor; and
at least one non-transitory computer readable medium comprising instructions stored thereon which when executed by the at least one processor configure the system to implement a method comprising:
obtaining a first set of primary training data labeled by associating these data with a first set of target property values;
applying the first set of primary training data to an input of the artificial neural network, to train, during a primary training, said neural network to identify at least one said target property value,
modifying at least one weight of the artificial neural network as a function of the first set of target property values and of the prediction scores obtained,
obtaining, for at least a first target value of a target property, a set of secondary training data;
applying, during a secondary training, at least one data of the set of secondary training data to the input of the neural network to identify an estimated value of said target property associated with at least one said secondary training data, by using the artificial neural network trained by said primary training;
obtaining, for each estimated value different from said first target value, a number of confusions corresponding to a number of times said estimated value has been estimated and to increase learning rates associated with said neurons of the output layer of said neural network associated with values of interest corresponding to estimated values with largest numbers of confusions.

15. The training system according to claim 14 wherein said properties are properties used to describe digital uses, said artificial neural network being configured to identify a digital use among a set of digital uses, each digital use being described by a digital behavior associated with at least one said property and by a digital environment associated with at least one said property,
said primary training comprising training said neural network to identify at least one target digital use among said set of digital uses, the data of said first set of primary training data being extracted from a first plurality of network packets captured during at least one execution of an application associated with said first target digital use, said primary training data being labeled by associating these data with a first set of target property values describing at least a digital behavior and a digital environment of said first target digital use,
the data of said set of secondary training data obtained for said at least one first target value being extracted from a second plurality of network packets captured during at least one execution of an application associated with a digital use whose said target property is described by said first target value.

16. A non-transitory computer—readable recording medium on which a computer program is recorded comprising instructions which, when executed by a computer, cause the computer to implement the execution of a method for training an artificial neural network so that said artificial neural network identifies at least one value of a property among a plurality of property values, each property being able to take at least two different values, said artificial neural network including an output layer including, for at least one said property value, a neuron configured to deliver a prediction score for said property value, said method comprising:
implementing a primary training comprising training said neural network to identify at least one target property value from a first set of primary training data labeled by associating these data with a first set of target property values;
implementing a secondary training including:
obtaining, for at least a first target value of a target property, a set of secondary training data;
identifying an estimated value of the target property associated with at least one said secondary training data, by using the artificial neural network trained by said primary training;
for each estimated value different from said first target value, obtaining a number of confusions corresponding to a number of times said estimated value has been estimated; and
increasing learning rates associated with said neurons of the output layer of said neural network that are associated with values of interest corresponding to estimated values with largest numbers of confusions.

17. (canceled)

18. (canceled)

19. (canceled)

20. (canceled)
